(19) United States
(12) Patent Application Publication
(10) Pub. No.: US 2018/0130986 A1
(43) Pub. Date: May 10, 2018

(54) METHOD OF MANUFACTURING BATTERY SEPARATOR USING TREATMENT OF MODIFYING SURFACE

(71) Applicant: Upex-chem Co., Ltd., Cheonan-si (KR)

(72) Inventors: Su Sun RYU, Cheonan-si (KR); Myoung Gu KANG, Cheonan-si (KR)

(21) Appl. No.: 15/797,449

(22) Filed: Oct. 30, 2017

(30) Foreign Application Priority Data
Nov. 9, 2016 (KR) 10-2016-0148601

(51) Int. Cl. H01M 2/14; H01M 2/18; B29C 47/00; B29C 59/14

(52) U.S. Cl. CPC H01M 2/145; H01M 2/18; B29L 2031/755; B29C 59/14; B29C 47/0057

(57) ABSTRACT

Provided is a method of producing a battery separator using surface modification treatment, which produces the battery separator by a dry process, satisfies air permeability and puncture strength properties required in the battery separator, and improves the thermal shrinkage and wettability of the battery cell, thereby appropriately responding to the trend for high-capacity and compact batteries. The method comprises: forming an unstretched sheet; subjecting the unstretched sheet to heat forming; cold-stretching the sheet subjected to the heat forming, thereby obtaining a cold-stretched film; hot-stretching the cold-stretched film by first hot stretching and second hot stretching; and heat-setting the film subjected to the second hot stretching, wherein corona discharge treatment is performed between the first hot stretching and the heat setting.

### BACKGROUND OF THE INVENTION

### Field of the Invention

The present invention relates to a method for producing a battery separator, and more particularly to a method for producing a battery separator, which comprises subjecting a battery separator, produced by a dry process, to corona discharge treatment to improve the physical properties of the battery separator.

### Description of the Prior Art

Battery separators are required to have good general physical properties such as mechanical strength and electrolyte permeability, and properties such as air permeability, puncture strength, wettability and the like are the important properties of the battery separators. Battery separators may be produced by various processes, and have different properties depending on the production processes. Processes for producing battery separators can be largely classified into a dry process and a wet process. The wet process is not environmentally friendly due to the use of an extraction solvent, and uses a complicated production process that reduces price competitiveness. In the dry process, a separator is produced by adding inorganic materials or controlling crystal structures. Since the separator produced by the method of adding inorganic materials has non-uniform pores and unstable quality such as reduced strength, the method of producing a separator by controlling crystal structures is frequently used.

The dry process that controls crystal structures is a method that comprises extruding a melted polymer resin to form an unstretched sheet, controlling the crystal structure of the unstretched sheet through heat forming, and stretching the sheet to form pores, thereby producing a separator. In U.S. Pat. No. 5,013,439 and the like, a process of forming pores by cold stretching and hot stretching is described in detail. The separator produced by the dry process is environmentally friendly because no extraction solvent is used, and the separator has high price competitiveness because the production process is simple.

Meanwhile, for the dimensional stability and property stability of a separator, the thermal shrinkage of the separator is preferably low. Furthermore, as a space into which an electrolyte is to be injected becomes narrower due to the trend for high-capacity and compact batteries, the wettability (impregnability) of the electrolyte is of increasing importance. If the wettability of the electrolyte is not good, many problems may arise in that the electrolyte overflows during injection, or remains on the top, or is not uniformly distributed in the battery cell, or contaminates equipment in subsequent processes. To overcome such problems, various methods have been adopted. However, a method that improves the thermal shrinkage and wettability of a separator while satisfying the air permeability and puncture strength properties of the separator has not yet been reported.

### SUMMARY OF THE INVENTION

It is an object of the present invention to provide a method of producing a battery separator using surface modification treatment, which produces the battery separator by a dry process, satisfies air permeability and puncture strength properties required in the battery separator, and improves the thermal shrinkage and wettability of the battery cell, thereby appropriately responding to the trend for high-capacity and compact batteries.

In the method of producing a battery separator using surface modification treatment according to the present invention, an unstretched sheet is first formed. Then, the unstretched sheet is subjected to heat forming. The sheet subjected to heat forming is cold-stretched. The cold-stretched film is hot-stretched by first hot stretching and second hot stretching. The film subjected to the second hot stretching is heat-set. In the method of the present invention, corona discharge treatment is performed between the first hot stretching step and the heat-setting step.

In the method of the present invention, the corona discharge treatment may be performed after the first hot stretching. The corona discharge treatment may also be performed after the second hot stretching. The corona discharge treatment may also be performed after each of the first hot stretching and the second hot stretching.

In a preferred embodiment of the method according to the present invention, the corona discharge treatment may comprise controlling a current between 0.3 A and 1.8 A based on the gap (1 mm) between electrodes when the film subjected to at least one step selected from among the first hot stretching and the second hot stretching is passed at a speed of 2 m/sec. The corona discharge treatment may enlarge the pore size of the film subjected to the stretching step. The film subjected to the corona discharge treatment has reduced thermal shrinkage and increased wettability compared to a film not subjected to the corona discharge treatment.

In a preferred embodiment of the method according to the present invention, the first hot stretching and the second hot stretching may be performed at a temperature between Tm−40° C. and Tm−10° C., wherein Tm is melting temperature of the film. The first hot stretching and the second hot stretching control the degree of stretching.

### BRIEF DESCRIPTION OF THE DRAWINGS

FIG. 1 is a flow chart showing a method of producing a battery separator according to a first embodiment of the present invention.

FIG. 2 is a flow chart showing a method of producing a battery separator according to a second embodiment of the present invention.

FIG. 3 is a flow chart showing a method of producing a battery separator according to a third embodiment of the present invention.

FIG. 4 is a 20,000× magnified photograph of a separator produced in Comparative Example 1.

FIG. 5 is a 20,000× magnified photograph of a separator produced in Comparative Example 2.

FIG. 6 is a 20,000× magnified photograph of a separator produced according to condition 1 in Example 1 of the present invention.

FIG. 7 is a 20,000× magnified photograph of a separator produced according to condition 2 in Example 1 of the present invention.

FIG. 8 is a 20,000× magnified photograph of a separator produced according to condition 3 in Example 1 of the present invention.

FIG. 9 is a 20,000× magnified photograph of a separator produced according to condition 4 in Example 2 of the present invention.

FIG. 10 is a 20,000× magnified photograph of a separator produced according to condition 5 in Example 2 of the present invention.

FIG. 11 is a 20,000× magnified photograph of a separator produced according to condition 6 in Example 3 of the present invention.

FIG. 12 is a 20,000× magnified photograph of a separator produced according to condition 7 in Example 3 of the present invention.

### DETAILED DESCRIPTION OF THE INVENTION

Hereinafter, preferred embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the invention to those skilled in the art.

Embodiments of the present invention provide a method for producing a battery separator, which comprises performing corona discharge treatment in a separator production process to thereby satisfy the air permeability and puncture strength properties required in the battery separator and improve the heat shrinkage and wettability of the battery separator, thereby appropriately responding to the trend for high-capacity and compact batteries. For this, a separator production process comprising corona discharge treatment will be explained in detail, and the physical properties of a battery separator produced by the process will be described in detail. A battery separator according to the present invention is produced by a dry process. Namely, an extraction solvent is not used, but in some cases, a solvent may also be used in a particle stretching process in which particles for forming pores are added. The following description will be focused on corona discharge treatment which is performed in a stretching process for producing a battery separator.

### First Embodiment

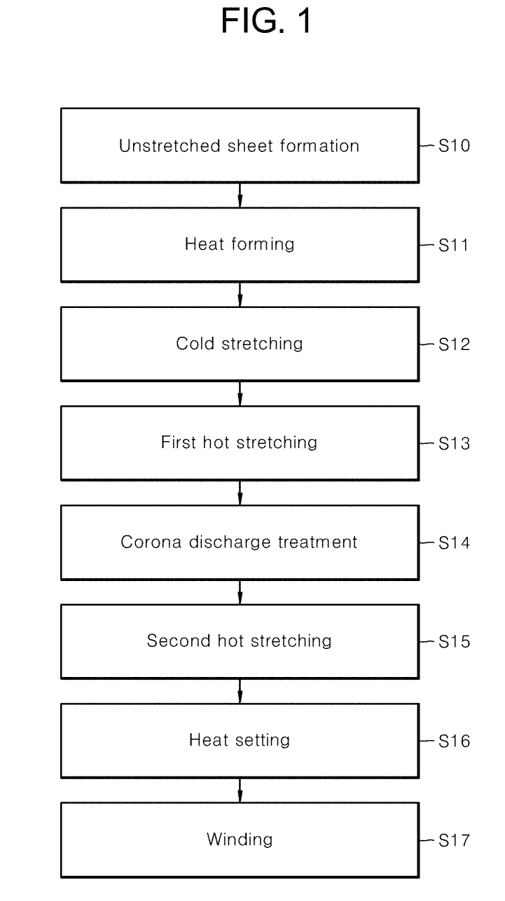

FIG. 1 is a flow chart showing a method for producing a battery separator according to a first embodiment of the present invention.

As shown in FIG. 1, in the first embodiment of the present invention, a polymer resin is first extruded to form an unstretched sheet (S10). Herein, the polymer resin is preferably semicrystalline, and may be, for example, a polymer compound selected from the group consisting of polyolefin, polyfluorocarbon, polyamide, polyester, polyacetal, polysulfide, polyvinyl alcohol, copolymers thereof, and combinations thereof. The polymer resin is preferably polyolefin resin, and example of the polyolefin resin include olefin homopolymers, including polypropylene, high-density polyethylene, low-density polyethylene, polybutene, polystyrene and the like, olefin copolymers, including ethylene-propylene copolymers, ethylene-butylene copolymers, propylene-butene copolymers and the like, and mixtures thereof.

When the polymer resin is extruded, various additives such as a reinforcing agent, a filler, an antioxidant, a surfactant, a neutralizing agent, a heat-resistant stabilizer, a weather-resistant stabilizer, an antistatic agent, a lubricant, a slip agent, a pigment and the like may be added within a range that does not obstruct the operation of a battery. The additives are not particularly limited as long as they are materials known in the art. Among such additives, the antioxidant is more preferably added in order to ensure long-term heat resistance and stability against oxidation.

An extrusion method for forming the unstretched sheet is not particularly limited, but may be performed using a single-screw or twin-screw extruder and a T-shaped or ring-shaped die. The melted polymer resin is discharged through the die and formed into the unstretched sheet by casting rolls. Meanwhile, in order to control the temperature of the discharged resin or allow the battery separator to be maintained in a good state in subsequent processes, air may be injected onto the casting rolls by use of an air knife or an air ring. The lamellae of the unstretched sheet are preferably oriented perpendicularly to the machine direction and stacked along the machine direction. The unstretched sheet in the present invention generally has a crystallinity of at least 20%, preferably at least 30%, most preferably 50%.

Next, the unstretched sheet is subjected to heat forming (S11). The heat forming acts to promote crystallization throughout the sheet, increase the size of crystals, and remove defects. The heat forming is performed for several seconds to several hours (e.g., 5 seconds to 24 hours, preferably about 30 seconds to 2 hours) at a temperature which is about 5° C. to 50° C. lower than the melting temperature of the polymer resin. For example, when the unstretched sheet is made of polypropylene, it is subjected to heat forming at a temperature of about 100° C. to 160° C. The heat forming may apply heat to the unstretched sheet by, for example, an oven in which heat convection occurs, contact with a heating roll, hot air in a tenter, or an IR heater, but is not particularly limited thereto.

Next, the unstretched sheet subjected to heat forming is cold-stretched to form cracks on the surface of the sheet (S12). In the cold stretching process, the sheet may be stretched in the machine direction by use of stretching rolls. The cold stretching process may be performed at a temperature that can form cracks in the amorphous region, depending on the kind of semicrystalline polymer compound forming the unstretched sheet. For example, the cold stretching process is preferably performed at a temperature between Tg−20° C. and Tg+70° C., wherein Tg is the glass transition temperature of the polymer compound used. At a temperature lower than Tg−20° C., the possibility of fracture during cold stretching is great and formation of uniform cracks is difficult. At a temperature higher than Tg+70° C., a phenomenon occurs in which the formed cracks are restored again by the thermal motion of the polymer. A preferred stretching ratio in the cold stretching process is 10 to 100%. When the stretching ratio is lower than 10%, cracks are not sufficiently formed in the amorphous region, and thus air permeability after hot stretching is reduced. When the stretching ratio is higher than 100%, fracture during the cold stretching process occurs to reduce production efficiency.

Next, the cold-stretched film is subjected to first hot stretching (S13). The first hot stretching is preferably performed at a temperature between Tm−40° C. and Tm−10° C., wherein Tm is the melting temperature of the film. At a temperature lower than Tm−40° C., the possibility of fracture during expansion of pores in the crack region of the cold-stretched film is high. The cracks formed through cold stretching are similar to some defects in the polymer, and when a force is applied to the cracks in a state in which sufficient heat is not applied thereto, fracture occurs mainly in the cracks. At a temperature higher than Tm−10° C., pores are closed because the flowability of the polymer is high.

Meanwhile, although the first hot stretching may be performed in various manners, machine direction stretching at a ratio of 100 to 300% is preferred. In some cases, transverse direction stretching may also be performed. However, in the first embodiment of the present invention, second hot stretching is subsequently performed, and thus the degree of stretching is controlled in the first hot stretching and the second hot stretching. For example, when the film is to be stretched by 140% in the machine direction, the film is stretched by about 70% in the first hot stretching and stretched by 70% in the second hot stretching. Accordingly, the first hot stretching serves to control the degree of stretching.

Next, the film subjected to the first hot stretching is subjected to corona discharge treatment (S14). Corona discharge is a phenomenon in which, when a DC voltage from a DC power source is increased using a conductor as an electrode and a metal plate as an opposite pole, a current flows while the electrode has a purple color. In the corona discharge treatment, the film subjected to the first hot stretching is placed between two electrodes in which corona discharge occurs, and constant power is supplied to the two electrodes to cause corona discharge to thereby modify the surface and inside of the film. The corona discharge treatment may be performed according to any conventional method. The amount of discharge in the corona discharge treatment may be in the range of 30 to 300 Wmin/m² or in the range of 50 to 120 Wmin/m², but is not limited thereto.

In the corona discharge treatment, corona discharge technology is used so that the surface of the film subjected to the first hot stretching becomes hydrophilic to have an increased ability to absorb an electrolyte that is a water-based medium. Namely, when the film subjected to the first hot stretching is subjected to corona discharge treatment, charged particles in corona collide with the surface of the film to oxidize the surface of the film. Thus, polar groups produced by oxidation of the surface, for example, C═O, C—O—H, COOH, —COO—, —CO—and the like, increase the surface energy of the film to thereby increase wettability that is the property of absorbing electrolyte. The corona discharge treatment produces the chemical polar groups as described above, and may also form a crosslinked structure on the surface of the film subjected to the first hot stretching, thereby increasing wettability.

In addition, the corona discharge treatment breaks a portion of molecular bonds on the surface or in the inside of the film subjected to the first hot stretching. In other words, a portion of molecular bonds in the film subjected to the first hot stretching is in a broken state. When a portion of molecular bonds is broken as described above, the size of pores on the surface or in the inside of the film subjected to the first hot stretching may be controlled using second hot stretching.

Next, the hot-stretched film subjected to corona discharge treatment is subjected to second hot stretching (S15). The second hot stretching is performed at a temperature between Tm-40° C. and Tm−10° C., like the first hot stretching, wherein Tm is the melting temperature of the film. The degree of stretching in the second hot stretching is controlled considering the degree of stretching in the first hot stretching. For example, when the film is to be stretched by 140% in the machine direction, the film is stretched by about 70% in the first hot stretching and stretched by 70% in the second hot stretching. When the second hot stretching is performed as described above, the battery separator according to the embodiment of the present invention is stretched several times the unstretched sheet subjected to heat forming. The battery separator subjected to the first and second hot stretching is heat-set to relax the heat applied to the separator and stabilize microstructures (S16). The battery separator subjected to heat setting is wound on a winding roll (S17).

### Second Embodiment

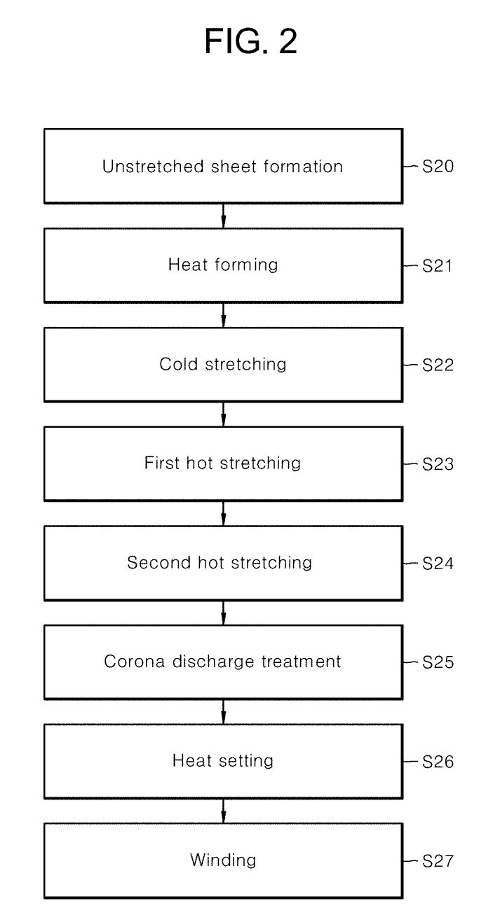

FIG. 2 is a flow chart showing a method for producing a battery separator according to a second embodiment of the present invention. The second embodiment is the same as the first embodiment, except that corona discharge treatment is performed after the completion of first hot stretching and second hot stretching. Accordingly, the detailed description of overlapping portions will be omitted below.

As shown in FIG. 2, in the second embodiment of the present invention, unstretched sheet formation (S20), heat forming (S21), cold stretching (S22), first hot stretching (S23), second hot stretching (S24), corona discharge treatment (S25), heat setting (S26) and winding (S27) steps are sequentially performed. As described above, the first hot stretching (S23) and the second hot stretching (S24) are preferably performed at a temperature between Tm−40° C. and Tm−10° C., wherein Tm is the melting temperature of the film. The degree of stretching in the second hot stretching is controlled considering the degree of stretching in the first hot stretching. For example, when the film is to be stretched by 140% in the machine direction, the film is stretched by about 70% in the first hot stretching and stretched by 70% in the second hot stretching. When the second hot stretching is performed as described above, the battery separator according to the embodiment of the present invention is stretched several times the unstretched sheet subjected to heat forming.

The features and effects of the corona discharge treatment (S25) are as described in the first embodiment. In the corona discharge treatment (S25), the film subjected to the second hot stretching is placed between two electrodes in which corona discharge occurs, and constant power is supplied to the two electrodes to cause corona discharge to thereby modify the surface and inside of the film. The corona discharge treatment may be performed according to any conventional method. The amount of discharge in the corona discharge treatment may be in the range of 30 to 300 Wmin/m² or in the range of 50 to 120 Wmin/m², but is not limited thereto.

### Third Embodiment

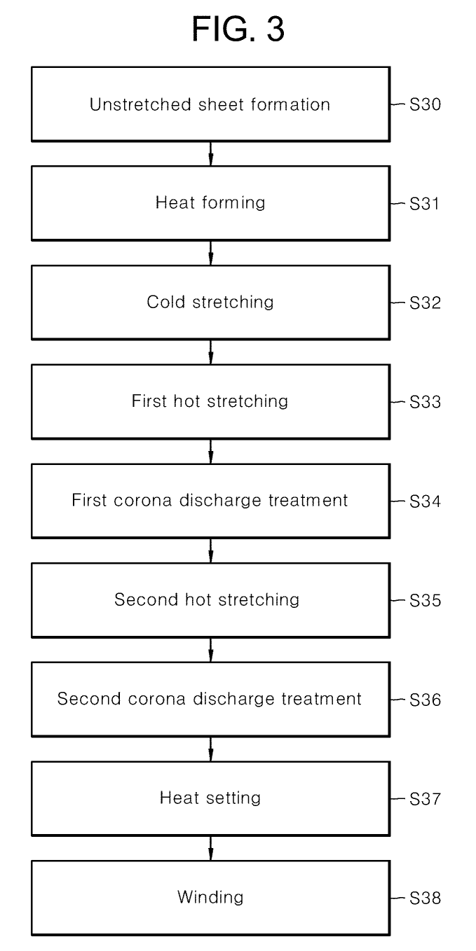

FIG. 3 is a flow chart showing a method for producing a battery separator according to a third embodiment of the present invention. The third embodiment is the same as the first embodiment, except that corona discharge treatment is performed after each of the first hot stretching and the second hot stretching. Accordingly, the detailed description of overlapping portions will be omitted below.

As shown in FIG. 3, in the third embodiment of the present invention, unstretched sheet formation (S30), heat forming (S31), cold stretching (S32), first hot stretching (S33), first corona discharge treatment (S34), second hot stretching (S35), second corona discharge treatment (S36), heat setting (S37) and winding (S38) steps are sequentially performed. As described above, the first hot stretching (S33) and the second hot stretching (S35) are preferably performed at a temperature between Tm−40° C. and Tm−10° C., wherein Tm is the melting temperature of the film. The degree of stretching in the second hot stretching is controlled considering the degree of stretching in the first hot stretching. For example, when the film is to be stretched by 140% in the machine direction, the film is stretched by about 70% in the first hot stretching and stretched by 70% in the second hot stretching. When the second hot stretching is performed as described above, the battery separator according to the embodiment of the present invention is stretched several times the unstretched sheet subjected to heat forming.

The features and effects of the first corona discharge treatment (S34) and the second corona discharge treatment (S36) are as described in the first embodiment. In each of the first corona discharge treatment (S34) and the second corona discharge treatment (S36), the film subjected to the first or second hot stretching is placed between two electrodes in which corona discharge occurs, and constant power is supplied to the two electrodes to cause corona discharge to thereby modify the surface and inside of the film. The corona discharge treatment may be performed according to any conventional method. The amount of discharge in the corona discharge treatment may be in the range of 30 to 300 Wmin/m² or in the range of 50 to 120 Wmin/m², but is not limited thereto.

Hereinafter, the following Examples will be presented in order to specifically describe the physical properties of the battery separator of the present invention. However, the scope of the present invention is not particularly limited to the following Examples. In addition, the physical properties of films shown in Examples and Comparative Examples represent the values measured by the following methods.

1) Air Permeability (sec)
Measurement instrument: Gurley Type Densometer model G-B2C (Toyoseiki, Japan).
Measurement method: in accordance with JIS P8117, the time (sec/100 ml) taken for 100 ml to pass was measured at a temperature of 23±2° C. and a relative humidity (RH) of 50±5%.

2) Puncture Strength (gf)
Measurement instrument: puncture strength meter (BMS Tech, Korea)
Measurement method: a puncture test was performed using a 1 mm probe, and the maximum puncture load was determined as puncture strength. Herein, a sample was inserted in a perforated metal frame (sample holder) having a hole of Φ11.3 mm, and the puncture strength of the sample was measured.

3) Heat Shrinkage (%)
Measurement instrument: convection oven
Measurement method: a square sample having a length of 10 cm was allowed to stand in an oven at 105° C. for 1 hour, and then the shrinkage of the sample in the machine direction was measured.

4) Wettability (dyne)
Measurement reagent: surface tension reagent (DIVERSIFIED ENTERPRISES, USA)
Measurement method: the reagent was applied to the surface of a film, and then the dyne value was measured.

### Example 1

According to the first embodiment as described above, an unstretched sheet made of a mixture resin comprising 98 wt % of polypropylene (homo PP) and 2 wt % of additives was formed. Next, the unstretched sheet was cold-stretched 1.3-fold at 45° C. for 30 seconds, and then first-hot-stretched 2.6-fold at 155° C. for 2 minutes. The first-hot-stretched film was subjected to corona discharge treatment while a current was controlled between 0.5 A and 1.5 A based on the gap (1 mm) between electrodes when the film was passed at a speed of 2 m/sec. Next, the film was second-hot-stretched 2.3-fold at 155° C. for 2 minutes, and then heat-set at 160° C. for 1 minute. After completion of the heat setting, the physical properties of the obtained battery separator were measured.

### Comparative Example 1

An unstretched sheet made of a mixture resin comprising 98 wt % of polypropylene (homo PP) and 2 wt % of additives was formed. Next, the unstretched sheet was cold-stretched 1.3-fold at 45° C. for 30 seconds, and then first-hot-stretched 2.6-fold at 155° C. for 2 minutes, and second-hot-stretched 2.3-fold at 155° C. for 2 minutes. Then, the film was heat-set at 160° C. for 1 minute. After completion of the heat setting, the physical properties of the obtained battery separator were measured.

### Comparative Example 2

An unstretched sheet made of a mixture resin comprising 98 wt % of polypropylene (homo PP) and 2 wt % of additives was formed. Next, the unstretched sheet was cold-stretched 1.3-fold at 45° C. for 30 seconds, and the cold-stretched film was subjected to corona discharge treatment while a current was controlled to 1 A based on the gap (1 mm) between electrodes when the film was passed at a speed of 2 m/sec. Next, the film was first-hot-stretched 2.6-fold at 155° C. for 2 minutes, and second-hot-stretched 2.3-fold at 155° C. for 2 minutes. Then, the film was heat-set at 160° C. for 1 minute. After completion of the heat setting, the physical properties of the obtained battery separator were measured.

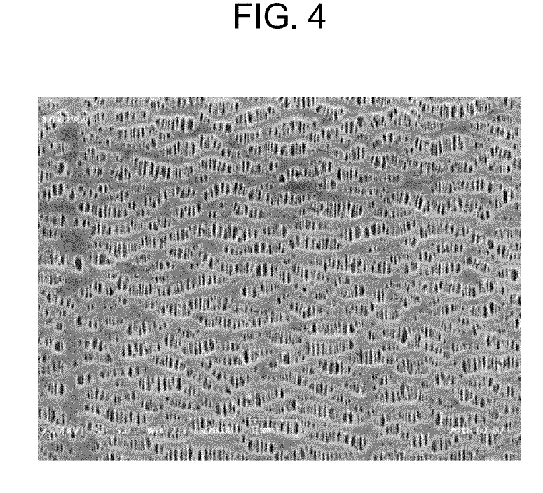

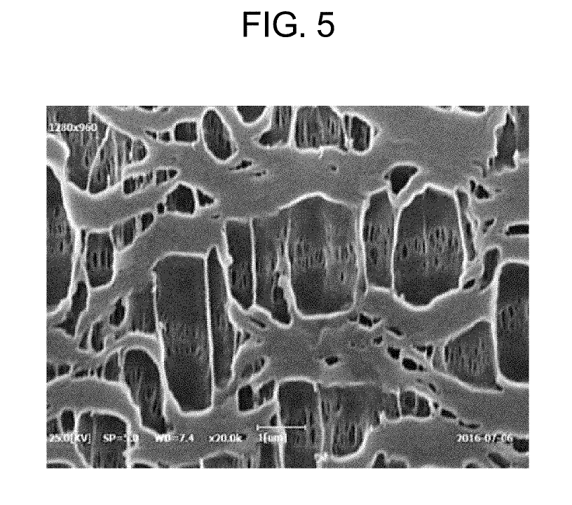

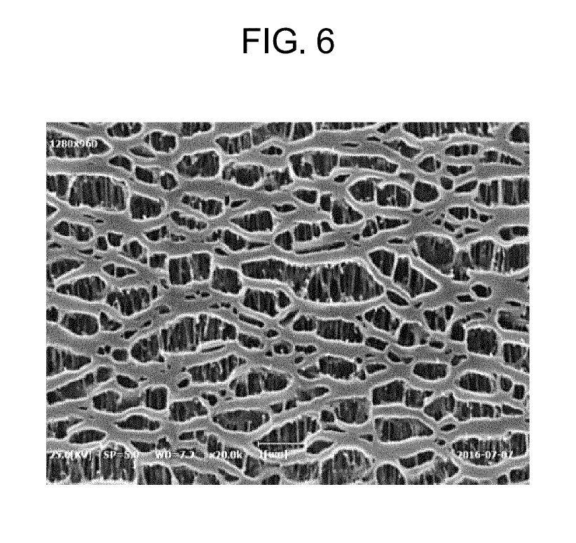

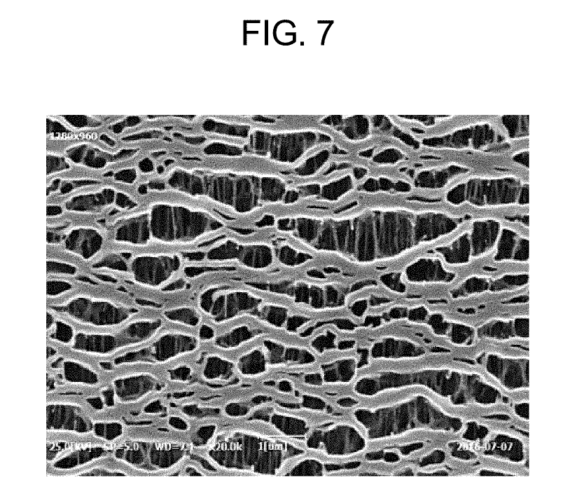

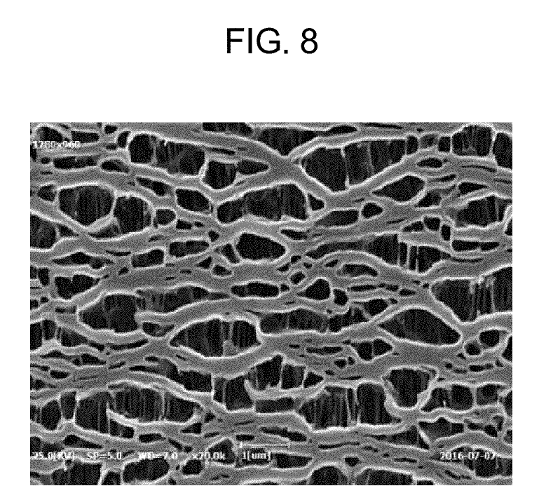

Table 1 below shows the physical properties of the battery separators produced in Example 1 corresponding to the first embodiment of the present invention and in the Comparative Examples. FIGS. 4 to 8 are 20,000× magnified photographs of the battery separators produced in Comparative Examples 1 and 2 and Example 1, respectively. FIGS. 6 to 8 are images of the battery separators produced according to conditions 1 to 3 in Example 1. The average thickness of the separators was 20 μm, and the heat shrinkages are values measured for the separators stretched in the machine direction at 105° C. Currents in conditions 1 to 3 were 0.5 A, 1 A and 1.5 A, respectively.

TABLE 1

| | | Air | Puncture | Heat | |
|---|---|---|---|---|---|
| | | permeability | strength | shrinkage | Wettability |
| | | (sec) | (gf) | (%) | (dyne) |
| Example 1 | Condition 1 | 348 | 389 | 5.5 | 37 |
| | Condition 2 | 340 | 335 | 5.5 | 37 |
| | Condition 3 | 328 | 318 | 5.5 | 37 |

| | | | | |
|---|---|---|---|---|
| Conparative Example 1 | 352 | 325 | 7.5 | 35 |
| Conparative Example 2 | 499 | 307 | 6 | / |

In Table 1 above, Comparative Example 1 is the battery separator subjected to the first and second hot stretching without corona discharge treatment, and Comparative Example is the battery separator is the battery separator subjected to corona discharge treatment after cold stretching. Accordingly, Comparative Example 1 can be regarded as a conventional separator, and Comparative Example 2 was performed to examine the relationship between corona discharge treatment and the separator production process. In Table 1 above, whether corona discharge treatment was performed and a suitable corona discharge treatment process can be seen.

Conditions 1 to 3 in Example 1 showed an air permeability of 328 to 348 sec, which was similar to or slightly smaller than that of Comparative Example 1, and showed a puncture strength of 318 to 389 gf, which did not greatly differ from those of the Comparative Examples. Accordingly, it could be seen that, in the Examples of the present invention, the air permeability and puncture strength of the separator were maintained at the levels of general separators, even when the separator was subjected to corona discharge treatment. However, Comparative Example 2, in which corona discharge treatment was performed after cold stretching, showed an excessively poor air permeability of 499 sec and a low puncture strength of 307 gf, indicating that Comparative Example 2 is not suitable as a battery separator. This is because the surface of the film was damaged by corona discharge treatment performed after cold stretching. Accordingly, the separator of Comparative Example 2, subjected to corona discharge treatment, is not preferable for battery applications in terms of air permeability and puncture strength.

The separators produced in Example 1 of the present invention all showed a heat shrinkage of 5.5%, and Comparative Examples 1 and 2 showed heat shrinkages of 7.5% and 6%, respectively. The heat shrinkages of the separators produced in Example 1 of the present invention were lower than those of Comparative Examples 1 and 2. Stretched battery separators necessary undergo heat shrinkage. However, for the dimensional stability and property stability of a battery separator, the thermal shrinkage of the separator is preferably low. It can be seen that the battery separators produced in Example 1 of the present invention were improved in terms of heat shrinkage.

The battery separators produced in Example 1 of the present invention all showed a wettability of 37 dyne, and the separator of Comparative Example 1 showed a wettability of 35 dyne. The separator of Comparative Example 2 had an excessively large pore size, and thus measurement of the wettability for the separator was not meaningful. Wettability is an important property that determines the impregnation of an electrolyte. As a space into which an electrolyte is to be injected becomes narrower due to the trend for high-capacity and compact batteries, the wettability (impregnability) of the electrolyte becomes poorer. If the wettability of the electrolyte is not good, problems may arise in that the electrolyte overflows during injection, or remains on the top, or is not uniformly distributed in the battery cell, or contaminates equipment in subsequent processes. When the wettability of a separator by an electrolyte is improved, the separator can appropriately respond to the trend for high-capacity and compact batteries. Accordingly, it is considered that Example 1 of the present invention improves the wettability of the separator, and thus is advantageous for providing a high-capacity and compact battery.

In Example 1 of the present invention, corona discharge treatment is performed after first hot stretching, and thus the air permeability and puncture strength of the separator are maintained at levels required in battery separators. In addition, the heat shrinkage of the separator is reduced, and the wettability of the separator is increased.

### Example 2

According to the second embodiment as described above, an unstretched sheet made of a mixture resin comprising 98 wt % of polypropylene (homo PP) and 2 wt % of additives was formed. Then, the unstretched sheet was cold-stretched 1.3-fold at 45° C. for 30 seconds, and then first-hot-stretched 2.6-fold at 155° C. for 2 minutes and second-hot stretched 2.3-fold at 155° C. for 2 minutes. The second-hot-stretched film was subjected to corona discharge treatment while a current was controlled to 0.8 A and 1.6 A based on the gap (1 mm) between electrodes when the film was passed at a speed of 2 m/sec. Next, the film was heat-set at 160° C. for 1 minute. After completion of the heat setting, the physical properties of the obtained battery separator were measured.

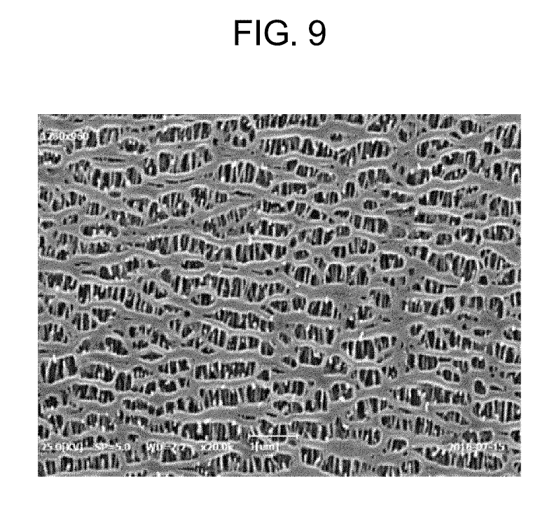

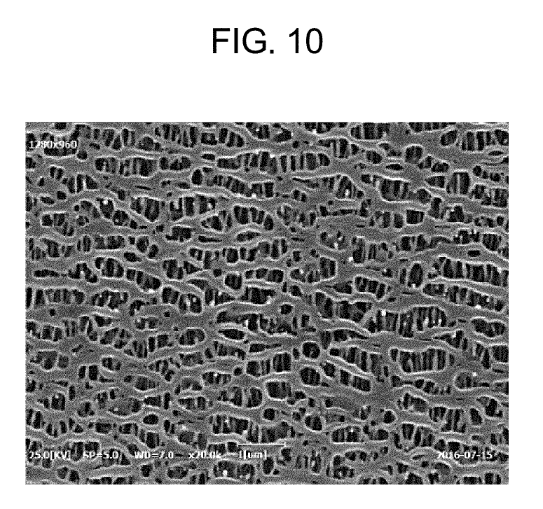

Table 2 below shows the physical properties of the battery separators produced in Example 2 corresponding to the second embodiment of the present invention and in the Comparative Examples. FIGS. 9 and 10 are 20,000× magnified photographs of the battery separators produced in Example 2, respectively. FIGS. 9 and 10 are images of the battery separators produced according to conditions 4 and 5 in Example 2. The average thickness of the separators was 20 μm, and the heat shrinkages are values measured for the separators stretched in the machine direction at 105° C. Currents in conditions 4 and 5 were 0.8 A and 1.6 A, respectively.

TABLE 2

| | | Air | Puncture | Heat | |
|---|---|---|---|---|---|
| | | permeability | strength | shrinkage | Wettability |
| | | (sec) | (gf) | (%) | (dyne) |
| Example 2 | Condition 4 | 307 | 293 | 6 | 36 |
| | Condition 5 | 293 | 263 | 6 | 36 |

| | | | | |
|---|---|---|---|---|
| Comparative Example 1 | 352 | 325 | 7.5 | 35 |
| Comparative Example 2 | 499 | 307 | 6 | / |

As can be seen in Table 2 above, Example 2 showed improved air permeability and reduced puncture strength compared to Comparative Example 1. However, the heat shrinkage and wettability of Example 2 were better than those of Comparative Examples 1 and 2. The puncture strength of Example 2 is a level that is applicable to a battery separator. In Example 2 of the present invention, corona discharge treatment was performed after second hot stretching, and thus the puncture strength of the separator was maintained at a level required in a battery separator, and the separator showed good air permeability, reduced heat shrinkage and increased wettability. However, the reduction in heat shrinkage and the increase in wettability of the separator of Example 2 were insignificant compared to those of Example 1. In other words, Example 2 is advantageous over Example 1 in that the air permeability of the separator is improved.

### Example 3

According to the third embodiment as described above, an unstretched sheet made of a mixture resin comprising 98 wt % of polypropylene (homo PP) and 10 wt % of additives was formed. Then, the unstretched sheet was cold-stretched 1.3-fold at 45° C. for 30 seconds, and then first-hot-stretched 2.6-fold at 155° C. for 2 minutes. The first-hot-stretched film was subjected to first corona discharge treatment while a current was controlled to 0.8 A and 1.6 A based on the gap (1 mm) between electrodes when the film was passed at a speed of 2 m/sec. The film subjected to the first corona discharge treatment was second-hot stretched 2.3-fold at 155° C. for 2 minutes. The second-hot-stretched film was subjected to corona discharge treatment while a current was controlled to 0.8 A and 1.6 A based on the gap (1 mm) between electrodes when the film was passed at a speed of 2 m/sec. Next, the film was heat-set at 160° C. for 1 minute. After completion of the heat setting, the physical properties of the obtained battery separator were measured.

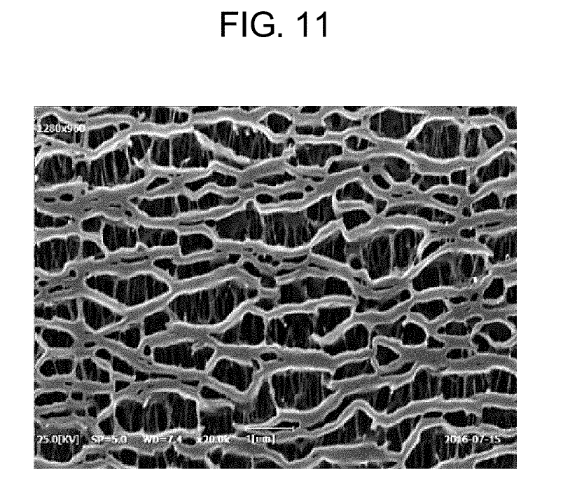

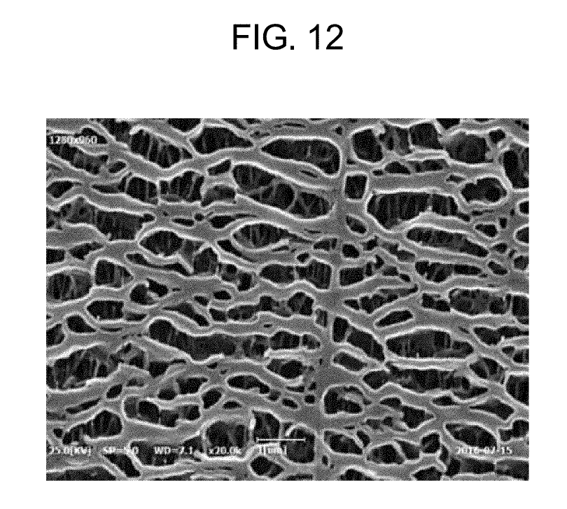

Table 3 below shows the physical properties of the battery separators produced in Example 3 corresponding to the third embodiment of the present invention and in the Comparative Examples. FIGS. 11 and 12 are 20,000× magnified photographs of the battery separators produced in Example 3, respectively. FIGS. 9 and 10 are images of the battery separators produced according to conditions 6 and 7 in Example 2. The average thickness of the separators was 20 μm, and the heat shrinkages are values measured for the separators stretched in the machine direction at 105° C. Currents in conditions 4 and 5 were 0.8 A and 1.6 A, respectively.

TABLE 3

| | | Air | Puncture | Heat | |
|---|---|---|---|---|---|
| | | permeability | strength | shrinkage | Wettability |
| | | (sec) | (gf) | (%) | (dyne) |
| Example 3 | Condition 6 | 293 | 282 | 5 | 36 |
| | Condition 7 | 270.5 | 254 | 5 | 36 |

| | | | | |
|---|---|---|---|---|
| Comparative Example 1 | 352 | 325 | 7.5 | 35 |
| Comparative Example 2 | 499 | 307 | 6 | / |

As can be seen in Table 3 above, Example 3 showed improved air permeability and reduced puncture strength compared to Comparative Example 1. However, the heat shrinkage and wettability of Example 3 were better than those of Comparative Examples 1 and 2. The puncture strength of Example 3 is a level that is applicable to a battery separator. In Example 3 of the present invention, corona discharge treatment was performed after each of first hot stretching and second hot stretching, and thus the puncture strength of the separator was maintained at a level required in a battery separator, and the separator showed good air permeability, reduced heat shrinkage and increased wettability. However, the heat shrinkage of Example 3 was equal to that of Example 1, and the increase in wettability of Example 2 was insignificant. In other words, Example 3 is advantageous over Example 1 in that the air permeability of the separator is improved and the heat shrinkage of the separator is reduced.

According to Examples 1 to 3 of the present invention, corona discharge treatment is performed after at least one process selected from among first hot stretching and second hot stretching. Thus, the heat shrinkage and wettability of the separator can be particularly improved while the puncture strength of the separator is maintained at a level required in conventional battery separators. Because the heat-set separator has a surface pore size that was increased by corona discharge treatment, it has increased wettability, and thus can be impregnated with an increased amount of an electrolyte. Even though the surface pore size is increased, the effects of reducing the heat shrinkage and increasing the air permeability can be obtained.

In particular, in corona discharge treatment, a current is preferably controlled between 0.3 A and 1.8 A based on the gap (1 mm) between electrodes when the film subjected to any one step selected from among first hot stretching and second hot etching is passed at a speed of 2 m/sec. If the current is lower than 0.3 A, the effect of corona discharge treatment will be insufficient, and if the current is higher than 1.8 A, the size of surface pores will be excessively large, and thus the separator will hardly be applied for battery applications.

As described above, according to the method of producing a battery separator using surface modification treatment according to the present invention, corona discharge treatment is performed in the process of producing the separator. Thus, air permeability and puncture strength properties required in battery separators can be satisfied, and the heat shrinkage and wettability of the battery separator can be improved, thereby appropriately responding to the trend for high-capacity and compact batteries.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method of producing a battery separator using surface modification treatment, the method comprising:
forming an unstretched sheet;
subjecting the unstretched sheet to heat forming;
cold-stretching the sheet subjected to the heat forming, thereby obtaining a cold-stretched film;
hot-stretching the cold-stretched film by first hot stretching and second hot stretching; and
heat-setting the film subjected to the second hot stretching,
wherein corona discharge treatment is performed between the first hot stretching and the heat setting.

2. The method of claim 1, wherein the corona discharge treatment is performed after the first hot stretching.

3. The method of claim 1, wherein the corona discharge treatment is performed after the second hot stretching.

4. The method of claim 1, wherein the corona discharge treatment is performed after each of the first hot stretching and the second hot stretching.

5. The method of claim 1, wherein the corona discharge treatment comprises controlling a current between 0.3 A and 1.8 A based on a gap (1 mm) between electrodes when the film subjected to at least one step selected from among the first hot stretching and the second hot stretching is passed at a speed of 2 m/sec.

6. The method of claim 1, wherein the corona discharge treatment enlarges a pore size of the stretched film.

7. The method of claim 1, wherein the corona discharge treatment reduces heat shrinkage of the film and increases wettability of the film, compared to a film not subjected to the corona discharge treatment.

8. The method of claim 1, wherein the first hot stretching and the second hot stretching are performed at a temperature between Tm−40° C. and Tm−10° C., wherein Tm is melting temperature of the film.

9. The method of claim 1, wherein the first hot stretching and the second hot stretching are divided in order to control the degree of stretching.
